(19) United States
(12) Patent Application Publication
(10) Pub. No.: US 2026/0330476 A1
(43) Pub. Date: Oct. 22, 2026

(54) METHOD AND SYSTEM FOR ALERTING CHANGES FOR SYSTEM DATA AND CODE CONFIGURATION WITH ARTIFICIAL INTELLIGENCE ASSISTED CHANGE CONTROL MANAGEMENT

(71) Applicant: JPMorgan Chase Bank, N.A., NEW YORK, NY (US)

(72) Inventors: Steve Arnold, Plano, TX (US); Scott D. Bertolino, West Grove, PA (US); Caitriona M. Deely, Bournemouth (GB); Jaroslaw A. Markocki, Brooklyn, NY (US); Kristin J. Belenger, Port Charlotte, FL (US); Walter David Thomas, Glassboro, NJ (US)

(73) Assignee: JPMorgan Chase Bank, N.A., NEW YORK, NY (US)

(21) Appl. No.: 19/186,175

(22) Filed: Apr. 22, 2025

(51) Int. Cl. G06Q 30/018; G06F 16/22

(52) U.S. Cl. CPC G06Q 30/0185; G06F 16/2282

(57) ABSTRACT

A method and system are provided for tracking configuration changes in an enterprise application platform (EAP) system involves monitoring data (DE) and configuration (CE) elements, conducting risk assessments on product processes, and using an artificial intelligence/machine learning (AI/ML) engine to trigger automated actions that mitigate risks and ensure system stability. A tool identifies changes to DEs and CEs within the EAP. Changes are input into a change management risk calculation tool, which returns an error rate for various processes and determines if this rate exceeds a predefined threshold. If the error rate surpasses the threshold, automated action may be generated in connection with AI/ML processing to address the issue.

### FIELD OF TECHNOLOGY

The present disclosure relates generally to configurable application platforms that can be enhanced by artificial intelligence (AI)/machine learning (ML) tools and AI/ML model training.

### BACKGROUND

In an enterprise application platform (EAP) that stores information in a centralized repository and manages enterprise application data, it is important that access to data and computer code, such as software scripts, be tightly managed to ensure that data elements, code, and processes, etc. are properly tracked and controlled. An EAP may typically contain a single enterprise-wide database including many tables, that contain records that share data. The EAP may also include many business applications for solving enterprise-wide problems. Further, the EAP may include a development environment (e.g., development platform) for altering applications and/or building new applications.

An EAP may serve to manage a cloud-based database accessed remotely over the Internet in connection with web-based tools connecting mobile devices, servers, workstations, personal computers, etc. EAP development may often be performed on a pro-code, low-code/no-code basis. Pro-code reflects software development according to a traditional methodology, while low-code/no-code reflects software development according to the use of interfaces/applications that minimize or, in the case of no-code, eliminate the need for the developer to be a skilled programmer.

EAPs are typically characterized by a user interface that makes use of tables, each table reflecting a variety of information arranged as rows of records having columns of field information. Data elements (DEs) may be regarded as the attribute of a type of data a column contains in a table. Configuration elements (CEs) may be regarded as any component that controls the functionality of the EAP. Data elements are meta data and are a subclass of CEs that are specifically concerned with how data are stored in the EAP.

A CE may be, for example, a software application or code that may be managed using various tools and methods including configuration files (e.g., web. config), graphical user interfaces, command-line interfaces, etc. As used herein, CEs include code and scripts affecting the function of the EAP.

A DE may refer to fields within a record such as those for name, address, telephone number, etc. A data element may be a table, a column/attribute or a property of a column/attribute.

An example of a DE is a user table column/attribute (e.g., first name,) including properties of the attribute (e.g., type=string, length=60 characters).

Developers are often given access to a variety of products in the EAP. It is important that products be carefully monitored and controlled, especially in cases where those products are shared among users and include shared applications or code. Further, data privacy concerns are at an all-time high. Code developers having access to data may generally have access to large swaths of data distributed in a database.

While no-code/low-code developers may encounter many guardrails that keep them within isolated (e.g., scoped) applications, pro-code developers face few such guardrails. Moreover, none of the current solutions targeted at governing pro-code development require product ownership validation before CEs can be modified. Additionally, none of the current solutions provide mechanisms to monitor cross-product impacts of changes to shared CEs.

### SUMMARY

Given the aforementioned deficiencies, a need exists to both identify DEs and CEs with products owned by clients in a cloud and/or on-premises computing environment and to provide controls to monitor and approve changes to DEs and CEs to maintain consistency across the platform.

The present disclosure, through one or more of its various aspects, embodiments, and/or specific features or sub-components, provides, inter alia, various systems, servers, devices, methods, media, programs, and platforms for implementing a system for inferring ownership of a product using an AI/ML model trained with historical data consisting of meta data associated with the product, database records and a combination thereof; and notifying an identified owner of a product, subject to a proposed change to an attribute of a database record, in an EAP, associated with the product. This includes the following:

In one embodiment, a method comprises inferring ownership of a product using an AI/ML model trained with historical data consisting of meta data associated with the product, database records and a combination thereof; and notifying an identified owner of a product, subject to a proposed change to an attribute of a database record, in an EAP, associated with the product.

In another embodiment, the method further comprises documenting within a database, the association of the product with one or more DEs and/or one or more CEs.

In another embodiment of the method, the proposed change to the attribute of the database record is a proposed change to a CE.

In another embodiment of the method, the configuration element is selected from the group consisting of scripts, configuration records, and applications.

In another embodiment of the method, the proposed change to the attribute of a database record is a proposed change to a DE.

In another embodiment of the method, the data element is a table within a database.

In another embodiment, the method, further comprises determining that the proposed change is shared in the EAP in connection with a plurality of products; performing a risk calculation check for each product of the plurality of products; and determining a potential error rate, in connection with the proposed change, associated with the plurality of products; and providing a response, based on the error rate, to the request

In another embodiment of the method, the proposed change to the attribute of a database record is a proposed change to a CE. In another embodiment of the method, the response, based on the error rate to the request, is selected from the group consisting of denying the change in connection with the error rate exceeding an error rate threshold and allowing the change in connection with the error rate being less than or equal to the error rate threshold.

In one embodiment, a database system comprises a first AI agent, trained using a large language model (LLM) to code changes to a DE and/or a CE; a second AI agent, trained to infer ownership of a product, based on historical ownership information and DE and/or CE database records; and a notification system configured to notify an owner of the product of a proposed change to a DE and/or a CE, on behalf of an entity other than an owner, the DE and/or the CE being associated with the product.

In another embodiment, the database system further comprises an approval system configured to permit the owner of the product to grant or deny the proposed change, by an entity other than the owner, to the DE and/or the CE.

In another embodiment, the database system is a cloud-based and/or on-premises database.

In another embodiment, the database system further comprises an alert system configured to provide notifications on an error rate exceeding a predetermined threshold.

In another embodiment, the database system further comprises a third AI agent, trained to infer duplicate scripts in connection with determining similarities of function, using an AI/ML model trained with script information, between a script change for a changed configuration element and a script already stored in a database, the third AI agent being configured to recommend the substitution of the script stored in the database for the script changed for the configuration element.

In one embodiment, a non-transitory computer-readable medium is configured to store instructions for implementing a processing system for identifying the ownership of a product wherein, when executed, the instructions cause a database management system to perform the following: cause a first AI agent, trained using an LLM to code changes to a DE and/or a CE; a second artificial intelligence AI agent, trained with historical data consisting of meta data associated with the product, database records and a combination thereof, to infer ownership of the product; cause a notification system to notify an owner of the product of a proposed change to an data element or configuration element associated with the product, by an entity other than the owner; and cause an approval system to permit the owner to grant or deny a change proposed by the entity.

In another embodiment, the instructions cause a database management system to further do the following: determine whether the element of a proposed change is shared by a plurality of products.

In another embodiment, the instructions cause a database management system to further do the following: perform a risk calculation check for each product of the plurality of products. wherein, the instructions cause a database management system to further do the following: determine an error rate, in connection with the proposed change, associated with each product of the plurality of products.

In another embodiment, the instructions cause a database management system to further do the following: determine an error rate, in connection with the proposed change, associated with each product of the plurality of products.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for the purpose of illustrating the embodiments and are not to be construed as limiting the disclosure. Given the following enabling description of the drawings, the novel aspects of the present disclosure should become evident to a person of ordinary skill in the relevant art(s).

FIG. 1A illustrates a diagram showing a system according to the disclosure.

FIG. 1B illustrates a flow diagram showing AI agent 104 that may serve to identify DEs and CEs within products among other things.

FIG. 1C outlines a process flow according to an AI agent for carrying out the process flow shown in FIG. 1B.

FIG. 2 illustrates a diagram representing a risk calculation and reporting engine.

FIG. 3A illustrates a diagram representing the functionality of a release risk calculation tool and a configuration alert tool for alerting changes, affecting a group of products.

FIG. 3B is a diagram showing multiple views on an exemplary dashboard in the embodiments.

FIGS. 4A and 4B illustrate the various roles and activities included in making, tracking, documenting and approving or rejecting changes to DEs and CEs according to the embodiments.

FIG. 5 illustrates a diagram representing AI/ML model dedicated to identifying code similarities and code differences in products in accordance with the embodiments.

FIG. 6A illustrates a workflow diagram showing a process embodiment according to the disclosure in connection with a development instance.

FIG. 6B illustrates a workflow diagram showing a process embodiment according to the disclosure in connection with a testing instance.

FIG. 6C illustrates a workflow diagram showing a process embodiment according to the disclosure in connection with a non-production synching with a production instance.

FIGS. 7A and 7B illustrate a workflow for a CE change/addition development effort.

FIGS. 8A and 8B illustrate a workflow for a DE change/addition development effort.

FIG. 9 illustrates configuration alert tool functionality for tracking and facilitating DE and CE changes across multiple instances.

FIG. 10 illustrates a system architecture schematic of tables used for carrying out the function and tasks disclosed herein.

Reference numerals have been carried forward.

### DETAILED DESCRIPTION

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process blocks, order of process block execution and omission of certain disclosed process blocks may be made without departing from the scope of the present disclosure.

The examples may also be embodied as one or more non-transitory computer-readable media having instructions stored thereon for one or more aspects of the present technology as described and illustrated by way of the examples herein. The instructions in some examples include executable code that, when executed by one or more processors, cause the processors to carry out blocks necessary to implement the methods of the examples of this technology that are described and illustrated herein.

A tool (hereinafter referred to as Tool) is disclosed for providing alerts in response to changes to DEs and CEs. The alerts concern changes that related to the EAP.

In addition, the Tool manages information in an EAP and it may determine the origin and ownership of such information. The Tool is set up to be highly available, resilient, and scalable. Tool access by users may occur via the Internet, with authentication and authorization handled by on-premise systems. Third-party systems may be integrated into the Tool to enable additional functionality not provided by the core Tool. On-premise systems may be integrated with the Tool, to handle functions such as sending data to the Tool and pulling data from the Tool. The Tool may track products globally to the extent of drilling down into all scopes where code and data are stored. Products may include intangibles that are delivered electronically. Products may also include digital products such as digital services, software applications, etc.

For instance, CEs are products or components that must be managed which deliver functionality on an EAP. Each application has a specific scope that can relate to a specific product or multiple products. The isolation of the scoped applications helps prevent conflicts and promotes the development of a database on a modular basis. Further, the isolation provided by scoped applications promotes security and maintainability. The Platform, as disclosed herein, may be considered as a database-agnostic tool. Specific data elements may be tracked for data lineage and data compliance and specific code CEs may be tracked for usage. Further, all DE and CE ownership may be tracked to distinct products and their product owners.

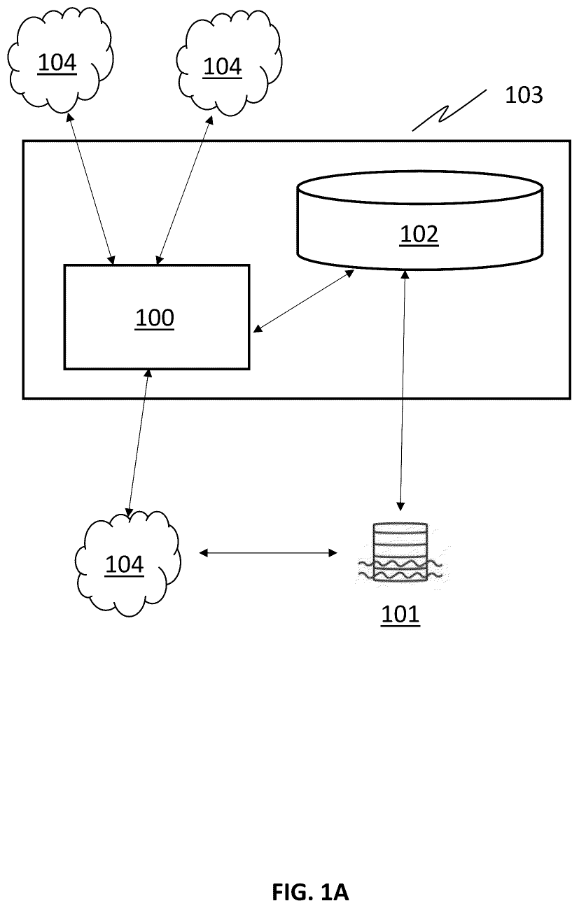

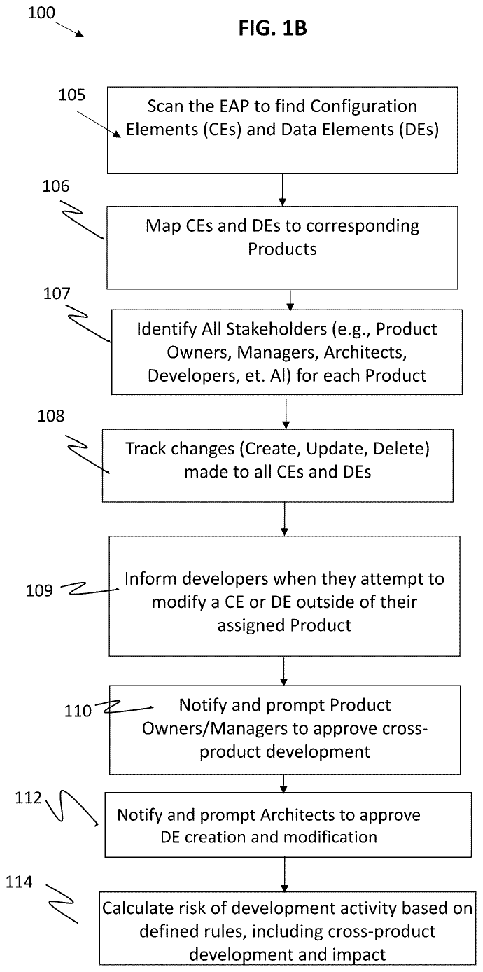

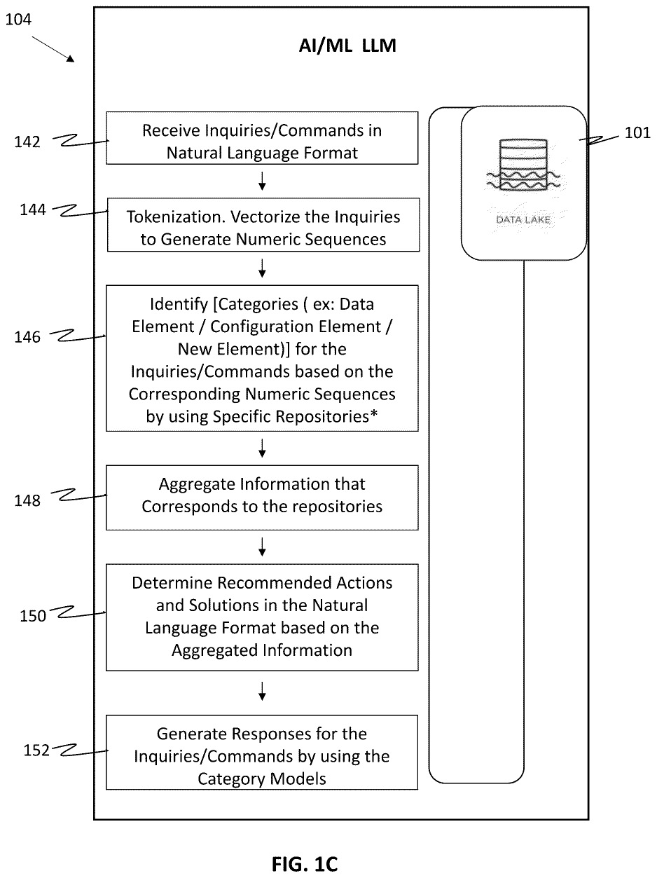

FIG. 1A illustrates a diagram showing a system according to the disclosure wherein Tool 100 may be part of EAP 103, utilizing EAP database 102, AI agent 104, and Data lake 101. AI agent 104 may employ an ML model: A ML model is a broad category that includes algorithms and statistical models that enable computers to learn from and make predictions or decisions based on data. Examples include decision trees, support vector machines, and clustering algorithms. Each AI agent 104 shown may represent one of the AI agents discussed herein.

For pro-code developers, Tool 100 (FIG. 1A) has been provided to address the lack of guardrails built into EAPs. Existing tools EAPs, to enable no-code/low-code development, have strict guardrails (such as enforcing the use of scoped applications) to ensure that applications under development do not interfere with other applications in a database. However, none of the solutions targeted at governing pro-code development provide product ownership validation against DEs and CEs being modified, nor do they provide mechanisms to monitor cross-product impact of changes to shared CEs.

FIG. 1B illustrates a flow diagram showing Tool 100 that serves to identify products, identify the attendant DEs and CEs associated with those products, and provide guardrails for developers, among other things.

Within an EAP serving as a database management system, particularly one employing a single tenant architecture, each customer entity is able to generate multiple copies of a database system, each copy being referred to as an “instance”. These instances are typically accessed by a uniform resource locator (URL) over a web browser. Each instance may run, side by side, different and multiple applications through the same URL, and data may be shared among applications in each instance, although in a single tenant architecture, data and processes are kept isolated across instances.

Typical types of instances include a development non-production instance for which an environment is provided to make changes to a system. Types of instances may also include a testing instance to test changes to a system and a production instance, the end result of changes being pushed from the development instance through to the testing instance, and on to the production instance. Changes to an instance may be made through a user interface in a fashion that may involve pro code, low code, or no-code scenarios.

In connection with, for example, pushing changes from a non-prod instance to a production instance, changes to data and processes should undergo an approval process to ensure consistency in data usage and processes. Toward that end, Tool 100 is programmed to receive and understand inquiries and respond accordingly, particularly for inquiries pertaining to changes in a development instance to data fields in a table. Tables serve as the backbone of a database management system for storing, organizing, and presenting data.

For example, in a development instance, changes to a data field in a record and/or changes to code in a container for a product may be identified. A record may be regarded as a horizontal line of information in a database organized according to columns of categories listed by fields. A container holds content for display by page on a user interface. Access to the page information in a container may be controlled in connection with using an access control list (ACL) that identifies entities granted access to attendant container information. Components or other containers are held in slots in the container.

Tool 100 (of FIG. 1A) may provide a response to a request to change a DE or CE in connection with a release risk determination as detailed herein and/or in connection with obtaining permission to make such a change in a product from the owner/manager of the product. An AI agent 104 (such as one of the AI agents shown in FIG. 1A) may be used to determine product ownership. The AI agent 104 may be trained to infer ownership of a product based on historical ownership information and DE and/or CE database records. Tool 100 may also track changes to a data dictionary (not shown). The data dictionary may hold field and table metadata detailing data types, table constraints, and field constraints. Tool 100 may serve to document product ownership, identify DEs and CEs, and associate those DEs and CEs with products.

With reference to FIG. 1B, the process flow and functionality associated with Tool 100 is as follows:

At step 105, EAP 103 is scanned to find CEs and DEs.

At step 106, CEs and DEs are mapped to corresponding products

At step 107, all stakeholders (e.g., product owners, managers, architects, developers, et al.) are identified for each product.

At step 108, platform changes are tracked (noted as created (Create), updated (Update), or deleted (Delete)) for all CEs and DEs.

At step 109, developers are alerted (informed) when they attempt to modify a CE or DE outside of their assigned product.

At step 110 Product Owners/Managers are notified and prompted to approve cross-product development

At step 112, architects are notified and prompted to approve DE creation and modification.

At step 114, the risk associated with a development activity is calculated based on defined rules, including cross-product development and impact.

The foregoing process flow shown in FIG. 1B may be implemented in connection one or more AI agents 104 employing an LLM in an AI/ML model. Large language models, such as GPT (Generative Pre-trained Transformer), are designed to understand and generate human-like text. They are particularly useful for natural language processing tasks, including text generation, translation, and summarization.

AI agents 104 may additionally employ a deep learning model. A deep learning model is a subset of machine learning that uses neural networks with many layers (deep networks) to model complex patterns in data. Deep learning models are effective for tasks like image and speech recognition, as well as natural language processing using a natural language processing model. Natural language processing (NLP) models are specifically designed to handle and analyze human language. They are used for tasks such as sentiment analysis, entity recognition, and language translation.

AI agents 104 may also employ a neural network model. Neural network models are inspired by the human brain and consist of interconnected nodes (neurons) that process information. They are versatile and can be used for a wide range of tasks, including classification, regression, and pattern recognition.

Further, AI agents 104 may employ a mathematical model. These models use mathematical expressions to represent relationships between variables. They are often used in simulations, optimizations, and quantitative analysis. Additionally, AI agents 104 may employ a process model. These models represent the steps or stages in a process, often used to analyze and improve business processes or workflows

FIG. 1C outlines a process flow according to AI agent 104 (one of which is shown in FIG. 1A). At block 142, inquiries/commands are received in a natural language format. One or more AI agents 104 through employing one or more AI/ML models may identify topics for each inquiry/command based on the numeric sequences generated in the previous step. Each topic is characterized by a subject matter value and a sentiment value, which help in understanding the context and emotional tone of the inquiry.

For processing inquiries/commands in a natural language format, the AI agent(s) 104 using a series of computational steps, natural language processing, machine learning models, and data aggregation, may be leveraged to provide insightful and actionable responses to user inquiries/commands. One or more inquiries/commands may be received through an application programming interface (API).

These inquiries/commands are in natural language format and may contain free-form data. The inquiries/commands may pertain to making changes in EAP records, such as changes in CEs or DEs. In addition, AI agent 104 may additionally code changes to a CE or DE based on the inquiries/commands. AI agent 104 may determine ownership of data elements, processes, and software code, including scripts, based on historical information contained in a database (which may be a cloud-based database). Ownership may also be inferred, in connection with AI/ML model training on metadata from the CE and or DE.

At block 144, data relevant to inquiries is tokenized. That is, sensitive data is replaced with unique identification symbols that retain all the essential information about the data without compromising its security. Each token is converted into a numerical sequence, representing a high-dimensional vector, through a process called vectorization. These types of vectors may be regarded as capturing the semantic meaning of each token and the LLM predicts the next tokens. Training of the LLM helps in the prediction of token sequences.

At block 146, categories are identified pursuant to a determination of a product (such as an application). For example, an application having certain DEs and/or CEs may be identified within specific application repositories in a database. An application repository is a centralized specific location where applications can be stored, accessed and distributed.

At block 148 information is aggregated corresponding to the identified topics from one or more sources. These sources may include a preconfigured data lake, which is a centralized repository for storing structured and unstructured data at any scale. At block 150, recommended actions and solutions in natural language format are determined based on the aggregated information.

At block 152, responses to inquires/commands are generated in natural language format. Each response may be based on aggregated information and may include recommended actions tailored to a predetermined setting. A response may include the identification of shared asset(s) in a category of products that a CE or DE change in a given product would affect. The response may also include code such as a script to perform the change to the DE or CE based on the natural language input (whether verbal through a microphone user interface or via a keyboard).

The aforementioned responses may be accomplished by one or more AI agent(s) (collectively or singularly referenced as 104). For instance, an AI agent 104 (FIG. 1A) may be trained using an LLM to code changes to a DE and/or a CE. The responses may include that which is crafted in natural language format, making it understandable and actionable for the end-user.

Data lake 101 is a data repository for storing, processing, and securing structured, semi-structured, and unstructured data. Data lake 101 provides the data upon which the AI agent 104 is trained. As information in Data lake 101 is updated, this information can serve to further train AI agent 104.

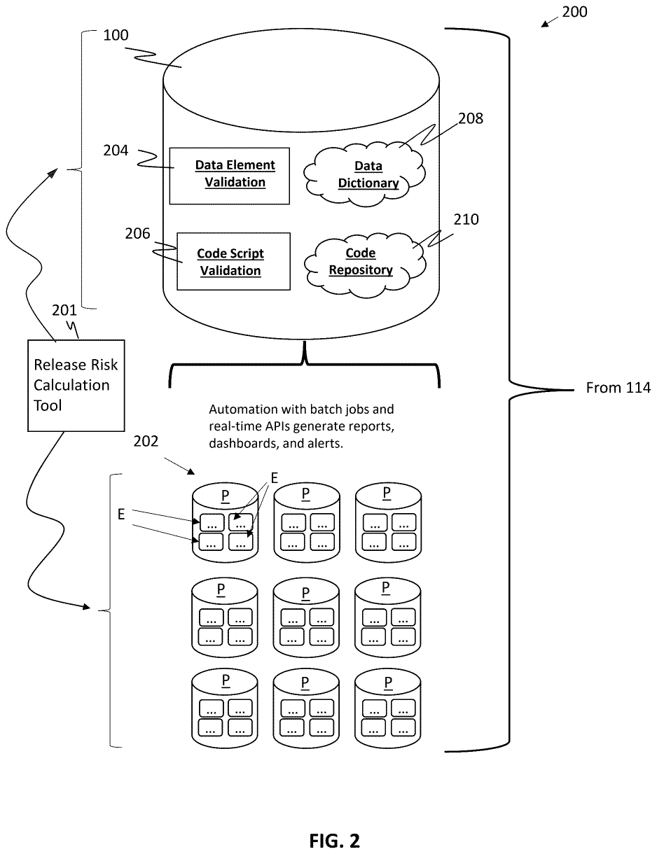

FIG. 2 illustrates a diagram representing risk calculation and reporting component 200. Risk calculation and reporting component 200 provides a threshold for determining whether database changes affect a DE or a CE pose an undue risk for the EAP. For instance, code changes to one process or application may present a deleterious change to another process or application. Tool 100 (FIG. 1B) may feed input to and be further expanded by integration with the risk calculation and reporting component 200.

Risk calculation and reporting component 200 may perform a risk calculation check on each process of a plurality of processes, identifying all DEs and CEs for input into release risk calculation tool 201. Release risk calculation tool 201 returns an error rate for the plurality of processes and determines whether that error rate exceeds an error rate threshold for any one of the plurality of processes. Should an error rate exceed a threshold, then relational database management system Tool 100 may implement an automated response to the error rate exceeding the error rate threshold. More specifically, risk calculation and reporting component 200 may perform, in conjunction with release risk calculation tool 201, the following tasks:
A) Confirm products 202 associated to each CE and DE. Each product is labeled “P” in FIG. 2. Each DE, CE and/or new element is represented by “E” in FIG. 2. For clarity of the drawing, only one product 202 is labeled showing elements marked “E.”
B) Specify product owner(s). Specific groups in a company may own products in an EAP. Ownership may be indicated by information within a particular data field. Additionally, ownership may even be inferred as a consequence of one or more of the following: product meta data; first use by an entity of a product in the EAP and frequent use of the product. These and other considerations concerning ownership may be determined in connection with inferences made by an AI agent of Tool 100.
C) Define rules for warning development users. Risk calculation and reporting component 200 may define rules for access and cause a notification to be sent online to a developer attempting to access information for which the developer has not been provided approval to modify.
D) Define rules for providing approvals. Particularly in cases where a developer needs access to change code or data for which no access is currently had, risk calculation and reporting component 200 may define protocols and procedures for obtaining permissions to access otherwise restricted elements.
E) Define rules for scripts analysis criteria. Because every DE may be defined in connection with using risk calculation and reporting component 200, this enables, for example, identification of data classification, data retention, and personally identifiable information (PII), etc., by data column.

Chargebacks can be applied for every piece of code and every piece of data. Chargebacks are amounts billed back for products that may be allocated, for example, to a customer or a department in an organization.

Tool 100 (FIG. 1A) which enables tracking every piece of code and column of data, for traceability purposes, in EAP Database 102 and Data lake 101 may contain risk calculation and reporting component 200 (FIG. 2). Risk calculation and reporting component 200 may play a key role for notification of any changes to data elements and/or configuration elements that may be dispatched to interested stakeholders (such as data owners) in an effort toward policing developers by keeping them in their assigned control lanes.

Risk calculation and reporting component 200 may also restrict data access by preventing developers from touching data and code outside of the scope of a given domain. Risk calculation and reporting component 200 runs on Tool 100. Tool 100 may include DE validation module 204 and code script validation module 206. DE validation module 204 may check for orphaned records in connection with DE changes. Code script validation module 206 may track how a script is used and re-used in multiple places, by product.

Risk calculation and reporting component 200 may additionally provide category validation within Tool 100, using DE validation 204, and code script validation 206, and may further reference data dictionary 208 and code repository 210.

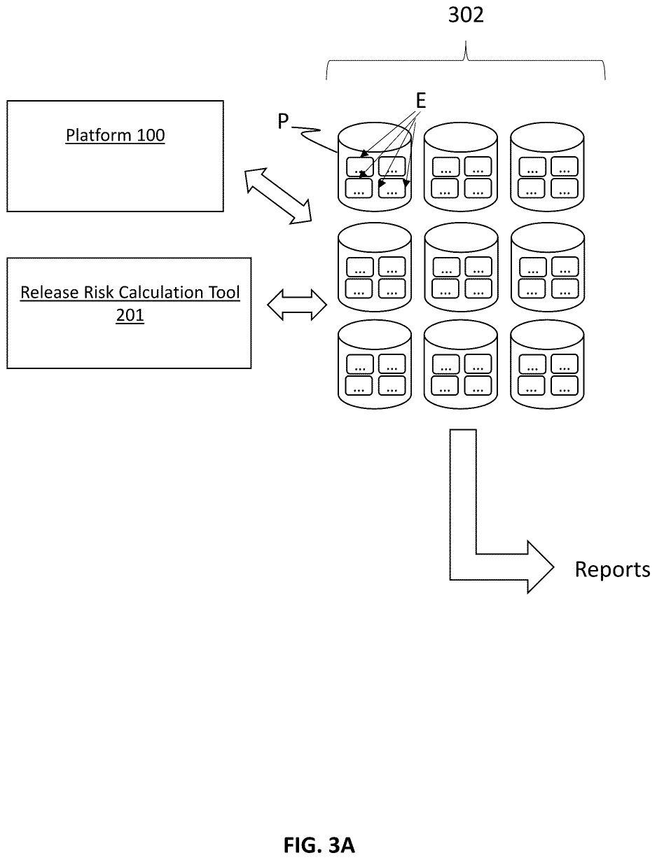

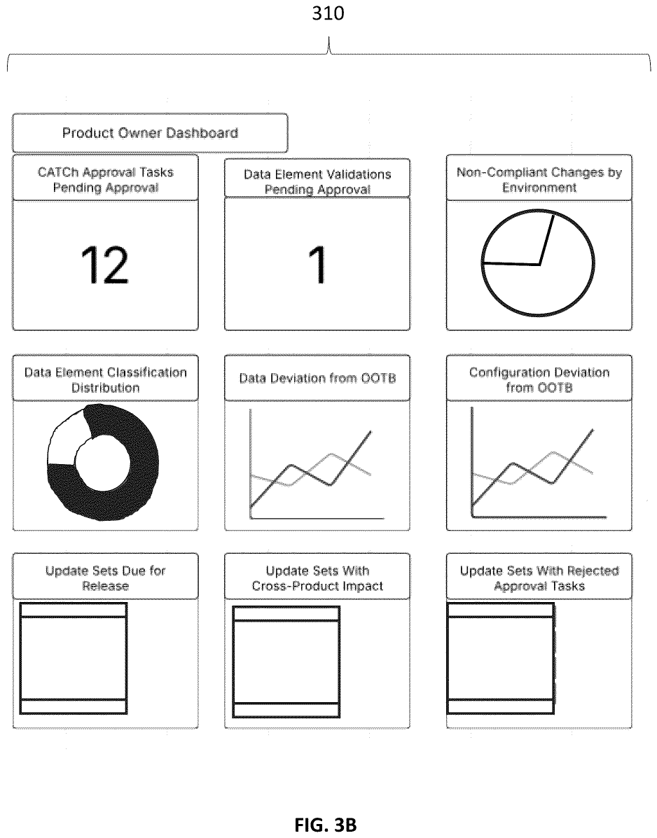

FIG. 3A illustrates a diagram highlighting the interaction of the release risk calculation tool 201 and the Tool 100, with a group of products 302, each product labeled “P” having elements (DEs and/or CEs). Elements (each element marked E) are labeled for only one product P for ease of illustration. As a consequence of this interaction, a variety of reports may be generated in conjunction with the application of release risk calculation tool 201 and the Tool 100. For example, reports may be generated on a dashboard of a user interface in connection with tracking code and data for traceability of CEs and DEs in products.

FIG. 3B is a diagram showing multiple views on an exemplary product owner dashboard 310. Visibility of any changes, via the dashboard, may help ensure that all DE and CE changes are captured and that developers stay within their assigned control lane as enforced by Tool 100. Multiple tables (not shown) may be used to capture and store DEs, CEs, and shared code reference data. These tables may contain platform configuration details that control what elements are captured from each instance and with what frequency.

These tables may exist in and may be populated with data from every instance of the platform, with all updates synchronized to the designated production instance, to facilitate configurable dashboards and reporting. As shown, FIG. 3B illustrates a sample dashboard concept which may be coined a “single pane of glass,” allowing the simultaneous viewing of CE values, DE values, release information, and technical debt. All product development efforts may be visible within these dashboards, showing, by product and by instance, where CE and DE changes have been made.

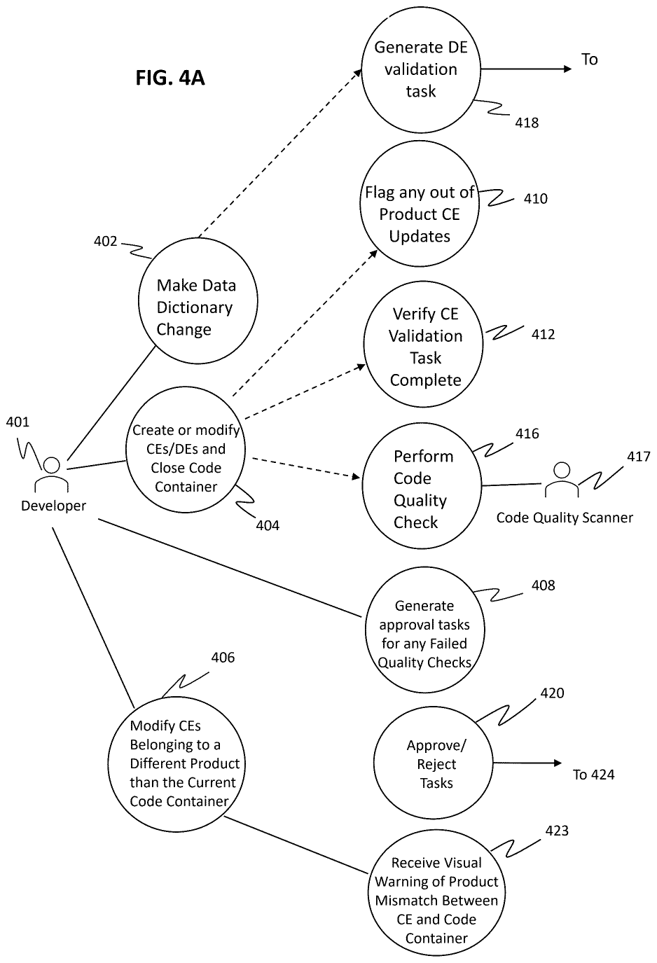

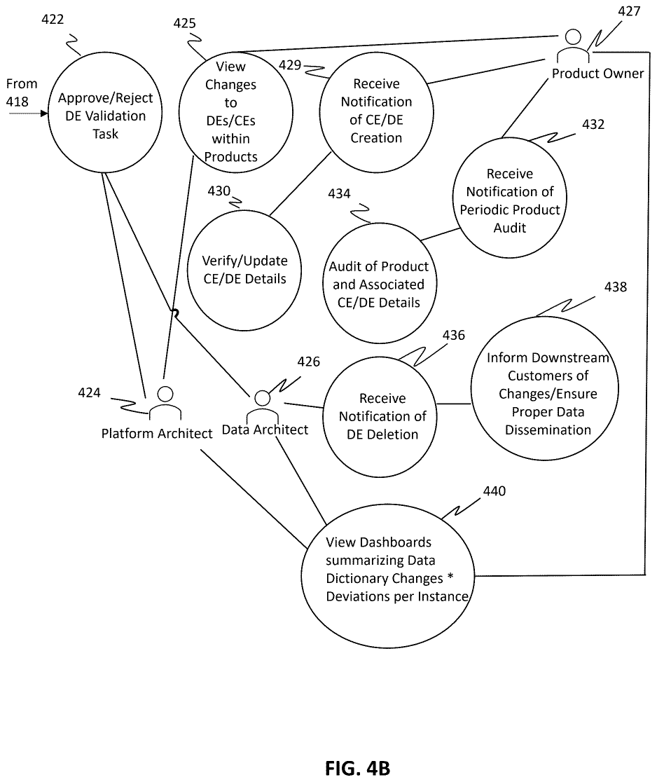

FIGS. 4A and 4B illustrate various roles and activities included in making, tracking, documenting, and approving/rejecting changes to DEs and CEs according to the disclosure. Developer 401 may perform the following at the noted numbered blocks: 402—make data dictionary changes; 404—create or modify CEs and/or DEs and close code containers; 406—modify CEs belonging to different products than the current code container; and 408-generate approval tasks for any failed quality checks. An approval task in this sense, refers to approving a CE and/or DE modification that does not pass one of the built-in code quality checks.

Creating or modifying CEs/DEs and closing code containers triggers: flagging any out-of-product CE updates 410, verifying that any CE validation tasks are complete 412, and performing a code quality check 416. The code quality check may be performed automatically or by code quality scanner 417. Making a data dictionary change 402 generates a DE validation task. Modifying CEs belonging to a different product than the current code container 406 results in receiving a visual warning 423 of a product mismatch between the CE and the code container. If this warning is ignored and changes are made outside of the currently assigned product, out of product CE updates are flagged 410 in the code container. While developers may have access to the full EAP platform, the modification of certain data fields and code may need to be restricted.

The approval or rejection of a DE validation task 422 may be performed by platform architect 424 and/or data architect 426. Platform architect 424 and data architect 426 may represent corporeal entities. However, it is also contemplated that these roles may be served by software/hardware or AI agents. Platform architect 424 views changes to DEs/CEs within products 425. Product owner 427 receives notification of CE/DE creation 429 which results in the verification/update of CE/DE details 430.

The product owner 427 also receives notification of periodic product audits 432 prior to the audit of a product and the associated CE/DE details 434. Data architect 426 receives notification of DE deletions 436 which results in informing downstream customers of changes to ensure proper data dissemination 438. Both platform architect 424 and data architect 426 can view dashboards summarizing data dictionary changes, e.g., deviations per instance 440.

With respect to FIGS. 4A and 4B, the process flow results in jobs running according to rules that manage data processing for Tool 100 (FIG. 1A). This may include rules for governing the processes needed to track all new and updated CEs and DEs. Other Tool 100 (FIG. 1A) processes may ensure that CE/DE data is kept current with other instances of the platform. Additional Tool 100 (FIG. 1A) processes may scan code containers to ensure that all rules and approvals are completed, including cross-product approvals, DE validation approvals, and risk score calculations, prior to code containers being migrated to other instances.

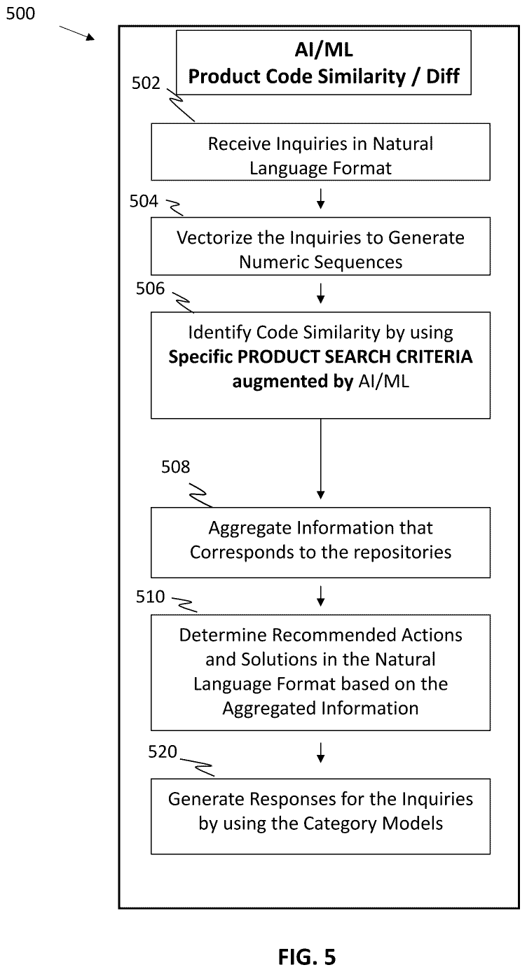

FIG. 5 illustrates a diagram representing AI/ML model 500 dedicated to identifying code similarities and code differences in products. In an effort to encourage uniformity in scripts and to discourage duplicative development efforts, AI/ML model 500 may serve as an AI agent to notify instances where similar code can be substituted with code such as scripts stored in a database. Noting similarities and differences in code has value in terms of being able to possibly re-use existing code or quickly modify existing code.

At block 502, an inquiry in natural language format is received. At block 504 the inquiry is vectorized to generate numeric sequences. At block 506 code similarities are identified using specific product search criteria augmented by AI/ML. At block 508, information is aggregated that corresponds to the repositories. At block 510 recommended actions and solutions are determined in a natural language format based on the aggregated information. At block 520, responses are generated for the inquiries by using the category models.

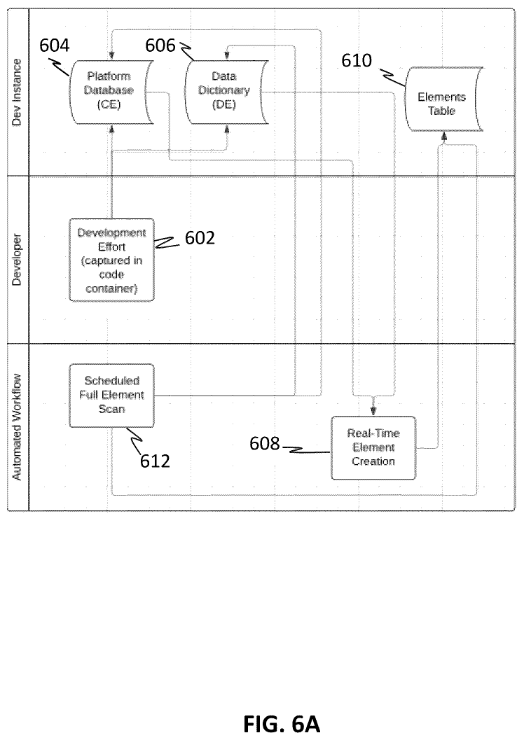

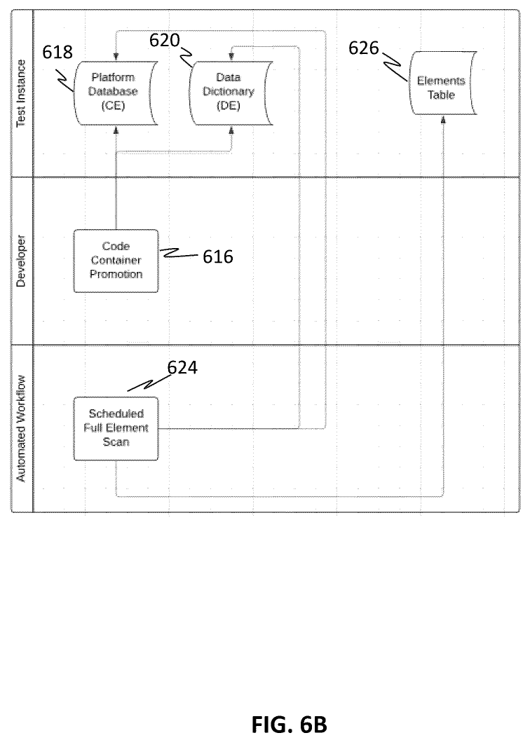

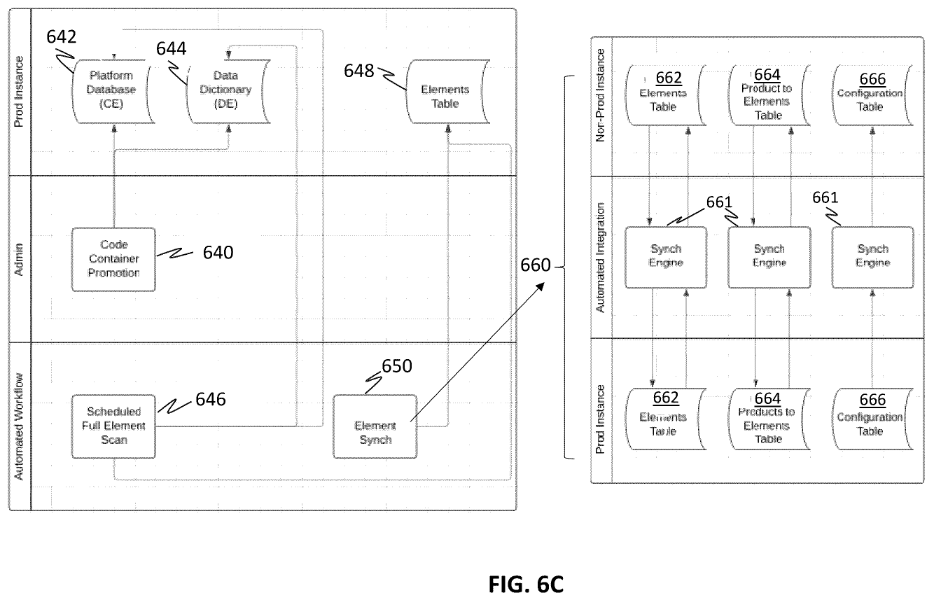

FIG. 6A illustrates a workflow diagram showing a process embodiment according to the disclosure in connection with a development instance. A developer, according to a development effort, captures changes in a code container 602. CEs, according to the development effort, are stored in a platform database 604. DE metadata, according to the development effort, is stored in the data dictionary 606. An automated workflow may include real-time element creation 608. Element creation refers to the process of creating records within elements table 610 that represent any new DE or CE created during development efforts. A full element scan of 612 elements created during the development may be conducted to advance the documentation and for review and approval of DE and CE changes/creations as noted herein.

FIG. 6B illustrates a workflow diagram showing a process embodiment according to the disclosure in connection with a testing instance. Code in container 616 is ready for promotion to a testing environment. The code promotion may be performed automatically or by a platform administrator. CEs are stored in a platform database 618. DE metadata is stored in the data dictionary 620. A full element scan 624 of elements in platform database 618 and data dictionary 620 ensure that element table 626 is fully populated for the testing instance.

FIG. 6C illustrates a workflow diagram showing a process embodiment according to the disclosure in connection with a non-production synching with a production instance. Code in container 640 is ready for promotion to another environment. CEs are stored in a platform database 642. DE metadata is stored in the data dictionary 644. A full element scan 646 of elements in platform database 642 and data dictionary 644 may be scheduled pursuant to synchronization.

Element synch 650 is responsible for initiating synchronization of DEs, CEs, processes, etc. as between a non-production instance and a production instance as illustrated in panel 660. The synchronization of DEs, CEs, processes, etc. may occur through automated integration of the same as provided by a respective synchronization engine 661 which serves to synchronize data as among a table of elements 662, a table of elements in products 664 and a table of CEs 666 as between a non-production instance (e.g., development instance) and a production instance.

Processes running on each instance of the platform may regularly synchronize the configuration CE and DE records between their instance and the designated primary instance. This synchronization also enables DE validation tracking and approvals to occur in the primary instance. Synchronization may also ensure that no data is lost during a clone-down event.

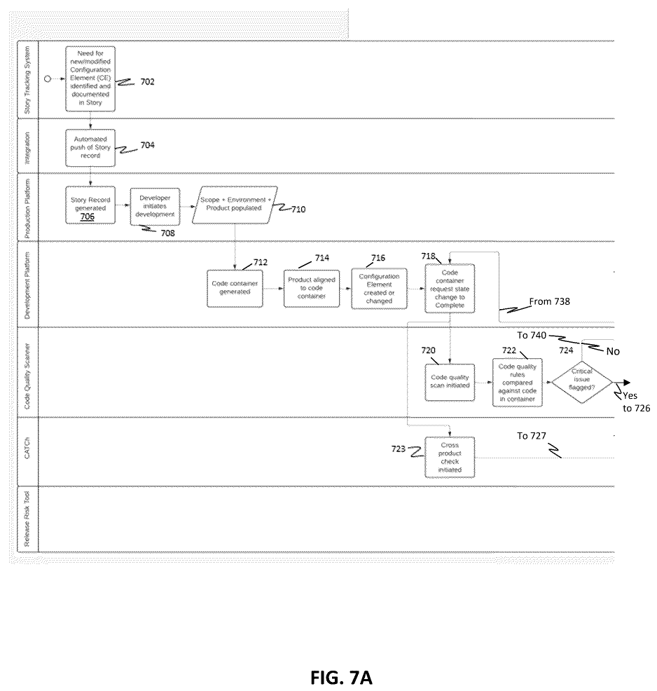

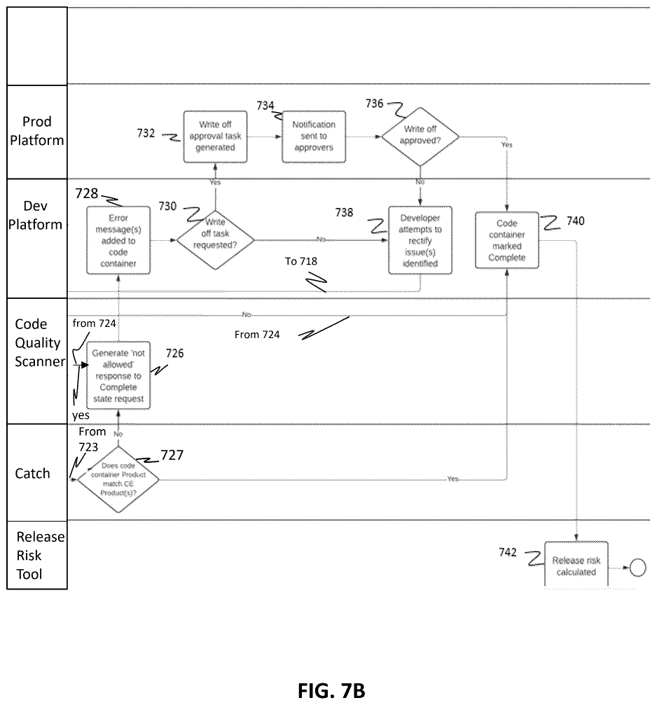

FIGS. 7A and 7B illustrate a workflow for a code configuration development effort. At block 702, a need for a new or modified CE is identified and documented in a story tracking system. A story is a specific type of work item to be completed within a sprint. A story tracking system creates, manages, and helps visualize user stories, writing sprints (fixed time periods during which a set of tasks must be completed and delivered to a customer), and product releases. The story tracking system is intended to track story progress and manage dependencies.

At block 704, in an integration between the story tracking system and the EAP, the story record is pushed into a production platform, and a story record is generated at block 706. At block 708, a developer initiates development, and at block 710, the scope, environment, and product fields pursuant to development are populated. At block 712, a code container is generated in the development instance, and at block 714, a product is aligned to the code container that was generated.

At block 716, a CE is created or changed. At block 718, a code container request state is changed to “complete”. The code container request state signifies the status of a code container change request. At block 720, the code (typically software) is subjected to a quality scan. At block 722 the code quality rules are compared with the code in the code container generated at block 712. At block 724, a decision tree is encountered, and a decision is made as to whether a critical issue, as a result of the quality scan, has been flagged. The flag associated with a critical issue helps ensure that developers stay within their assigned control lanes. This prevents touching data and code outside of the scope of a developer's domain. This is a highly important task as very sensitive information may be involved.

If the decision is “no,” as shown in FIG. 7B, the code container is marked complete at block 740. If the decision is “yes”, a “not allowed response” is generated in response to the state request at block 718. At block 723, shown in FIG. 7A a cross-product check is also initiated in response to the code container request at block 718. This cross-product check results in a decision at block 727 in response to determining whether the code container product matches the CE product.

As the code container packages code and dependencies so that an application may run in a variety of environments, the workflow of Tool 100 (FIG. 1A) prevents unauthorized code elements outside of the assigned product. Consequently, should there not be a match at block 727, a “not allowed response” is generated in response to the state request at block 718. Generation of “not allowed’ responses at block 726 results in the generation of an error message or error messages being added to a code container with the code change.

At block 730, a decision is made as to whether an approval task has been requested. If the decision is “no,’ then the developer attempts to rectify the issue identified as problematic. Afterward, the request for a state change is made again at block 718. Should the effort to change the CE(s) be retained, an approval task is generated at block 732, and a notification is sent to approvers at block 734. At block 736, the approval results in the code container being marked complete. Should no issue be found with the CE change, the code container is marked complete at block 740.

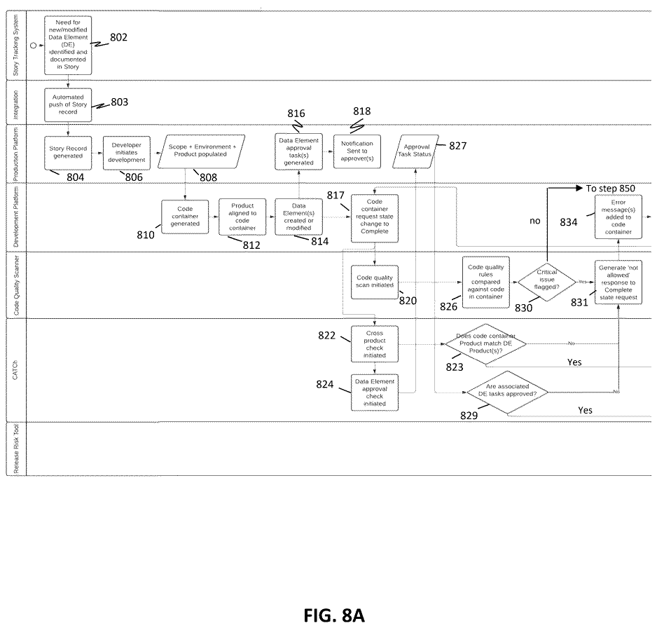

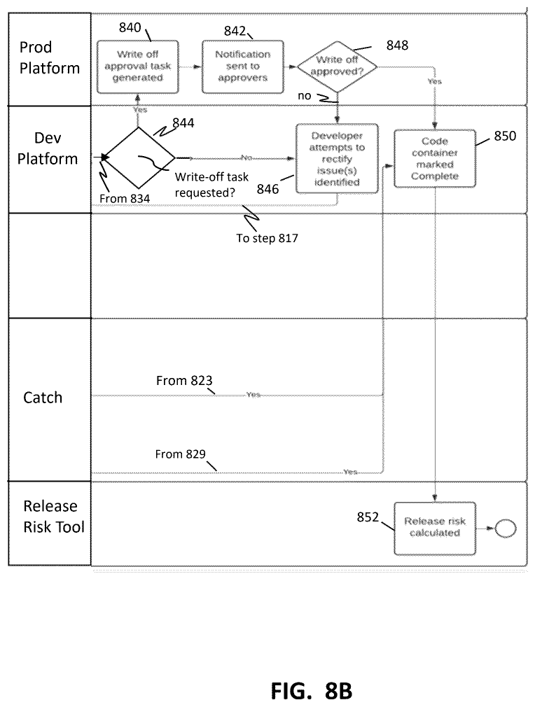

FIGS. 8A and 8B illustrate a workflow for a data element change/addition development effort. At block 802 a need for a new or modified DE is identified and documented in a story tracking system. At block 803, in an integration stage, the story record is pushed to the production platform. On a production platform, the story record is recorded at block 804. At block 806, a developer initiates a development effort. At block 808, the scope, environment, and product fields are populated. At block 810, a code container is generated in the development instance.

At block 812, a product is aligned to the code container. At block 814, a DE is created or modified. At block 817, a code container request state change is completed. At block 820, a code quality scan is initiated. At block 826, code quality rules are compared against the code in the container. At block 830 a determination is made as to whether a critical issue has been flagged. The flag associated with a critical issue helps ensure that developers stay within their assigned control lanes. This prevents touching data and code outside of the scope of a developer's domain. This is a highly important task as very sensitive information may be involved.

If a critical issue has not been flagged, the code container is marked complete at block 850 (FIG. 8B). At block 822 a cross-product check for a DE is initiated. Thereafter, a DE approval check is initiated at block 824. An approval task status is requested at block 827. At block 829, a decision is made as to whether associated DE tasks are approved. If no, a “not allowed” response is generated. Thereafter, an error message is added at block 834 to the code container generated at block 810.

If the decision is “yes,” the code container is marked complete at block 850. At block 823, after the cross-product check is initiated, a decision is made as to whether the code container product matches the DE product. If the code container product matches the DE product, the code container is marked complete in block 850. If there is no match, the “not allowed” response is generated at block 831 in response to the code generated at block 810.

It is noted that the workflow of Tool 100 checks for code alignment between the container product and the DE product. Further, the workflow of Tool 100 covers the approval of DE tasks.

Once a container is marked complete at block 850, the risk of release is calculated at block 852 according to the risk release calculation tool 201 of FIG. 2. At block 844 of a development platform (Dev Platform), a decision is made as to whether an approval task has been requested in connection with an error message added to a code container regarding a DE change/addition. If an approval task has not been requested, a developer may attempt, at block 846, to rectify the issue identified with the error message(s) at block 834. After such an attempt, a code container request state change is made at block 817, restarting the DE change request process.

In the case of an approval task request at block 844, an approval task is generated at block 840. A notification of the approval request is sent to approvers at block 842. A determination is made as to whether the approval task is approved at block 848. If the approval task is approved the code container is marked complete at block 850. If the approval task is not approved, then the developer, at block 846, may attempt to rectify the issue (new or previous) identified with the error message(s) at block 834.

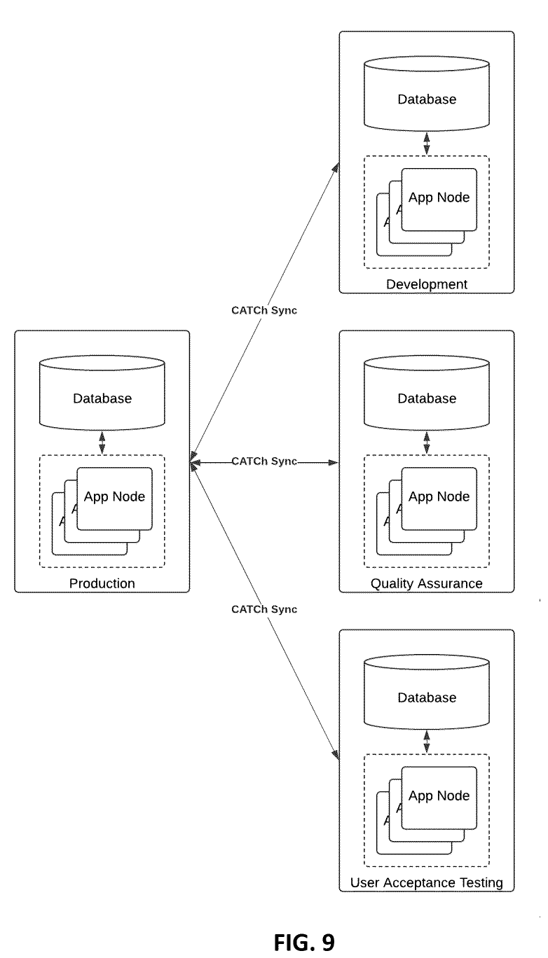

FIG. 9 illustrates configuration alert tool functionality for tracking and facilitating DE and CE changes. Tool 100 (FIG. 1A) processes running on each instance of Tool 100 (FIG. 1A) regularly synchronize the CE and DE records between their instance and the designated primary instance. This synchronization also enables DE validation tracking (see 204, FIG. 2) and approvals to occur in the primary instance. Synchronization also ensures that no data of Tool 100 (FIG. 1A) is lost during a clone-down event (e.g., copying over a lower-level instance from a higher-level instance).

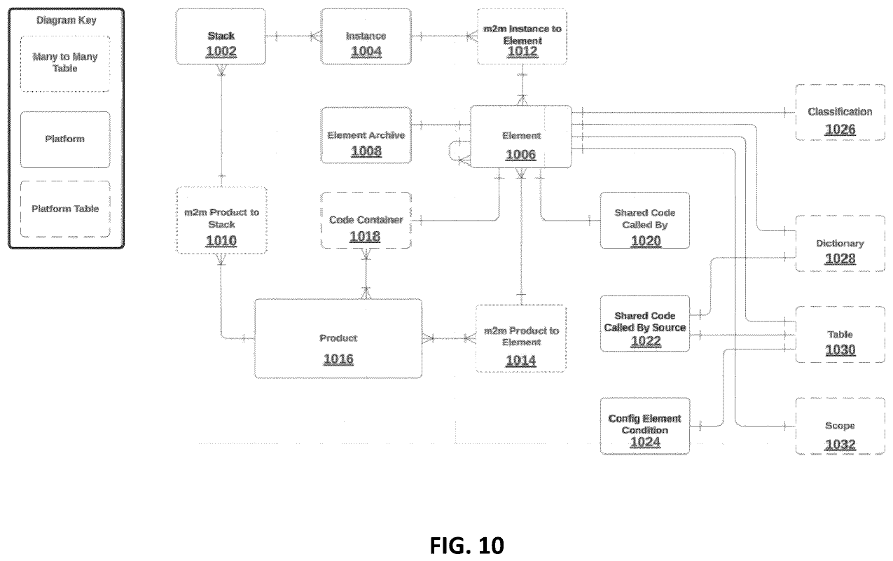

FIG. 10 illustrates a system architecture schematic of tables used for carrying out the function and tasks disclosed herein. Stack table 1002 includes multiple stacks, and each stack will typically have one or more development instances, a quality assurance (QA) instance, a user acceptance (UAT) instance, and a production instance. Stack table 1002 defines which stacks are included in efforts to alert changes to system data and code configurations. Each record in the table corresponds to a stack and its associated child records are in the instance table 1004.

Instance table 1004 defines which instances exist within each stack for inclusion in Tool 100 (FIG. 1A). Each record in the table corresponds to an instance and contains the details about that instance, including its role in the stack (e.g., development, QA, product, etc.).

Element table 1006 stores all the element records, whether DEs or CEs. Based on the type of element (DE or CE), multiple details about that element are stored in element table 1006.

Element archive table 1008 serves as a repository for elements whenever an element (DE or CE) is deleted from a stack. The delete element moved to element archive table 1008 includes the element record along with its metadata. Element archive table 1008 provides a historical record of all deleted elements, including any unique identifiers added by Tool 100 (FIG. 1A).

Many-to-many (m2m) product-to-stack table 1010 is a many-to-many table that tracks which product exists in which stack. This table is used by dashboards and reports to allow product owners and other interested parties to see which products exist in which stack.

Many-to-many (m2m) instance-to-element table 1012 is a many-to-many table that tracks which elements (DE and CE) exist in which instance. This table is used by dashboards and reports to allow Product Owners and other interested parties to see where each element exists at any given time.

Many-to-many (m2m) product-to-element table 1014 is a many-to-many table that tracks which element belongs to which product. This table is used by dashboards and reports to allow product owners and other interested parties to see which elements exist within each product.

Product table 1016 may be populated with products identified by Tool 100 (FIG. 1A).

Code container table 1018 may include code container contents pursuant to development efforts.

Shared code called by table 1020 may contain shared code elements called by other CEs in Tool 100 (FIG. 1A).

Shared code called by source table 1022 contains a list of the tables that can be scanned for references to shared code.

The data dictionary may consist of two tables-table 1030 and dictionary 1028, containing a list of all tables and fields in the database, respectively.

Classification table 1026 may contain a list of data classifications that can be associated with data fields (e.g., Public, Internal, Confidential, etc.) in Tool 100 (FIG. 1A).

Scope table 1032 may contain applications identified in Tool 100 (FIG. 1A) as scoped applications.

The following features may be realized in connection with the forgoing Tool 100 (FIG. 1A) as detailed herein although other advantages may be realized:
A) Scanning and DE validation for monitoring schema changes may provide a type of customized guardrail against developers altering data and processes, which, for perhaps a variety of reasons, they should not change.
B) Tool 100 (FIG. 1A) permits the ability to define products that exist in each platform stack and it allows the documentation of CEs and DEs associated with those products.
C) Tool 100 (FIG. 1A) may facilitate the alignment of code containers to a product upon creation of the code container and may permit the flagging of any changes made in the code container that are associated to a different product to minimize the impact of cross-product development.

D-1) Tool 100 (FIG. 1A) may provide the ability for product owners to document data classification, data retention and other DE metadata at the table and column level.

D-2) Tool 100 (FIG. 1A) may provide the ability for AI/ML AGENT to suggest data classification, data retention and other DE metadata at the table and column level.

E) Tool 100 (FIG. 1A) may provide visibility of the use (by product) of global/shared CEs, and it allows evaluation of the impact of changes to shared code.

F) Tool 100 (FIG. 1A) may allow custom tables to be designated as either data or configuration tables, to allow for the appropriate control enforcement.

G) Tool 100 (FIG. 1A) may provide exception approval processes for warnings flagged against CEs when cross-product development is, for instance, appropriate and necessary.

H) Tool 100 (FIG. 1A) may track deletion of CE and DE elements to eliminate orphaned records and streamline a developer experience at this tollgate.

I) Tool 100 (FIG. 1A) may provide visibility of instances in which each CE/DE resides.

J) Tool 100 (FIG. 1A) may provide an AI/ML Code Similarity Search to assist in reducing duplicate code during the development process. Pursuant to this Code Similarity Search, an AI agent (such as one the AI agents 104 (shown in FIG. 1A) may be used to determine duplicate scripts. The AI model may be trained to infer duplicate scripts in connection with determining similarities of function, using an AI/ML model trained with script information, between a script change proposed for a CE and a script already stored in a database.

Consequently, Tool 100 (FIG. 1A) may provide advantages that include:
A) providing improved platform governance and risk control by product;
B) providing improved visibility and transparency of configuration and data element changes in EAP 103 (FIG. 1A);
C) providing a mechanism to tighten controls around movement, changes, and exporting of data;
D) enabling change/release automation to be further data driven based on attributes on custom tables; and
E) allowing developers to see and mitigate any cross-scope impact during the development process instead of reactively.

It should be understood that there can be several application servers, layers, or other elements, processes, or components, that may be chained or otherwise configured. These components can interact to perform tasks such as obtaining data from an appropriate data store.

Servers, as used herein, may be implemented in various ways, such as hardware devices or virtual computer systems. In some contexts, servers may refer to a programming module being executed on a computer system.

As used herein, unless otherwise stated or clear from context, the term “datastore” or “data store” refers to any device or combination of devices capable of storing, accessing, and retrieving data, which may include any combination and number of data servers, databases, data storage devices, and data storage media, in any standard, distributed, virtual, or clustered environment.

The environment, in one embodiment, is a distributed and/or virtual computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated.

As described above, a set of instructions may be used in the processing of the foregoing. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software may instruct the processing machine what to do with the data being processed.

Further, it is appreciated that the instructions or set of instructions used in the implementation and operation of the foregoing may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the foregoing. Illustratively, the programming language used may include assembly language, Ada, APL, Basic, C, C++, COBOL, dBase, Forth, Fortran, Java, Modula-2, Pascal, Prolog, Python, REXX, Visual Basic, and/or JavaScript, for example. Further, it is not necessary that a single type of instruction or single programming language be utilized in conjunction with the operation of the system and method of the foregoing. Rather, any number of different programming languages may be utilized as is necessary and/or desirable.

Also, the instructions and/or data used in the practice of the foregoing may utilize any compression or encryption technique or algorithm, as may be desired. An encryption module might be used to encrypt data. Further, files or other data may be decrypted using a suitable decryption module, for example.

As described above, the foregoing may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium.

That is, the particular medium, i.e., the memory in the processing machine, utilized to hold the set of instructions and/or the data used in the foregoing may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the foregoing.

Further, the memory or memories used in the processing machine that implements the foregoing may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

Additionally, various technologies may be used to provide communication between the various processors and/or memories, as well as to allow the processors and/or the memories of the foregoing to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As will be appreciated, although a web-based environment is used for purposes of explanation, different environments may be used, as appropriate, to implement various embodiments.

Although the present application describes specific embodiments that may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method, comprising:
inferring ownership of a product, using an artificial intelligence/machine learning model (AI/ML), the AI/ML model being trained with historical data consisting of meta data associated with the product, database records and a combination thereof; and
notifying each identified owner of a product, subject to a proposed change to an attribute of a database record, in an enterprise application platform (EAP), associated with the product.

2. The method according to claim 1, further comprising documenting within a database, the association of the product with one or more data elements (DEs) and/or one or more configuration elements (CEs).

3. The method according to claim 2, wherein the proposed change to the attribute of the database record is a proposed change to a configuration element (CE).

4. The method according to claim 3, wherein the CE is selected from the group consisting of scripts, configuration records, and applications.

5. The method according to claim 2, wherein the proposed change to the attribute of a database record is a proposed change to a data element (DE).

6. The method according to claim 5, wherein the DE is a field attribute within the database record.

7. The method according to claim 5, wherein the DE is a table within the database.

8. The method of claim 1, further comprising:
determining that the proposed change is shared in the EAP in connection with a plurality of products;
performing a risk calculation check for each product of the plurality of products;
determining a potential error rate, in connection with the proposed change, associated with the plurality of products; and
providing a response, based on the error rate, to a request to change the attribute of the database record.

9. The method according to claim 8, wherein the proposed change to the attribute of a database record is a proposed change to a data element (DE).

10. The method according to claim 8, wherein the proposed change to the attribute of a database record is a proposed change to a configuration element (CE).

11. The method according to claim 8, wherein the response is selected from the group consisting of denying the change in connection with the error rate exceeding an error rate threshold and allowing the change in connection with the error rate being less than or equal to the error rate threshold.

12. A database system, comprising:
a first artificial intelligence (AI) agent, trained using a large language model (LLM) to code changes to a data element (DE) and/or a configuration element (CE);
a second artificial intelligence (AI) agent, trained to infer ownership of a product, based on historical ownership information and data element (DE) and/or configuration element (CE) database records; and
a notification system configured to notify an owner of the product of a proposed change to the DE and/or the CE, on behalf of an entity other than an owner, the DE and/or the CE being associated with the product.

13. The database system according to claim 12, further comprising an approval system configured to permit the owner of the product to grant or deny the proposed change, by an entity other than the owner, to the DE and/or the CE.

14. The database system according to claim 12, wherein the database system is a cloud-based and/or on-premises database.

15. The database system according to claim 12, further comprising a risk release calculation tool for calculating an error rate associated with a proposed change to a DE or a CE and an alert system configured to provide notifications by the notification system on an error rate exceeding a predetermined threshold.

16. The database system according to claim 12, further comprising an AI agent, trained to infer duplicate scripts in connection with determining similarities of function, using an AI/ML model trained with script information, between a script change proposed for a configuration element and a script already stored in a database,
the third AI agent being configured to recommend the substitution of the script stored in the database for the script change proposed for the configuration element.

17. A database system, comprising:
an artificial intelligence (AI) agent for determining product ownership, trained to infer ownership of a product, based on historical ownership information and data element (DE) and/or configuration element (CE) database records; and
a notification system configured to notify an owner of the product of a proposed change to a DE and/or a CE, by an entity other than the owner, the DE and/or the CE being associated with the product.

18. The database system according to claim 17, further comprising an approval system configured to permit the owner of the product to grant or deny the proposed change, by an entity other than the owner, to the DE and/or the CE.

19. The database system according to claim 17, wherein the database system is a cloud-based and/or on-premises database.

20. The database system according to claim 17, further comprising a risk release calculation tool for calculating an error rate associated with a proposed change to a DE or a CE and an alert system configured to provide a notification of an error rate exceeding a predetermined threshold.

21. The database system according to claim 17, further comprising an artificial intelligence (AI) agent for determining duplicate scripts, trained to infer duplicate scripts in connection with determining similarities of function, using an AI/ML model trained with script information, between a script change proposed for a configuration element and a script already stored in a database,
the AI agent for determining duplicate scripts being configured to recommend the substitution of the script stored in the database for the script change proposed for the configuration element.

22. A non-transitory computer-readable medium configured to store instructions for implementing a processing system for identifying the ownership of a product wherein, when executed, the instructions cause a database management system to perform the following:
cause a first artificial intelligence AI agent, trained with historical data consisting of meta data associated with the product, database records and a combination thereof, to infer ownership of the product;
cause a notification system to notify an owner of the product of a proposed change to an data element or configuration element associated with the product, by an entity other than the owner; and
cause an approval system to permit the owner to grant or deny a change proposed by the entity.

23. The non-transitory computer-readable medium according to claim 22, wherein, the instructions cause a database management system to further do the following:
determine whether the element of a proposed change is shared by a plurality of products.

24. The non-transitory computer-readable medium according to claim 23, wherein, the instructions cause a database management system to further do the following:
perform a risk calculation check for each product of the plurality of products.

25. The non-transitory computer-readable medium according to claim 23, wherein, the instructions cause a database management system to further do the following:
determine an error rate, in connection with the proposed change, associated with each product of the plurality of products.
